(19) United States
(12) Patent Application Publication
(10) Pub. No.: US 2015/0371743 A1
(43) Pub. Date: Dec. 24, 2015

(54) COMPOSITE MAGNETIC MATERIAL

(71) Applicant: TOMOEGAWA CO., LTD., Tokyo (JP)

(72) Inventors: Takeshi HASHIMOTO, Shizuoka-shi (JP); Takuma HATTORI, Yaizu-shi (JP); Kojiro TSURUTA, Shizuoka-shi (JP)

(21) Appl. No.: 14/743,801

(22) Filed: Jun. 18, 2015

(30) Foreign Application Priority Data
Jun. 20, 2014 (JP) 2014-127155

(51) Int. Cl. H01F 1/01; C22C 38/08; C22C 38/06; C22C 38/02

(52) U.S. Cl. CPC H01F 1/01; C22C 38/02; C22C 38/08; C22C 38/06; C22C 2202/02

(57) ABSTRACT

A composite magnetic material has sufficient flexibility and can be produced with a high producing ability without having inferior form. The composite magnetic material contains soft magnetic metal powder and resin composition containing an A component, which is an acryl copolymer with an epoxy group, and a B component, which is phenol resin, in which the soft magnetic metal powder is dispersed in the resin composition, and a mass ratio denoted by the A component/the B component is 4 to 99. It is preferable that the mass ratio denoted by the soft magnetic metal powder/the A component+the B component) be 1 to 49.

### BACKGROUND OF THE INVENTION

1. Field of the Invention

The present invention relates to a composite magnetic material used for absorbing electromagnetic noise generated by electronic devices, etc., that prevents the noise from being emitted to the outside or penetrating to the inside, and prevents malfunctions due to interference between electronic components in electronic devices, the composite magnetic material being flexible so that it can be made to conform to unevenness on a circuit board, an electronic component, a flexible printed circuit board, etc., and maintaining flexibility and dimensional stability after a long term heat resistant reliability test at 150 degrees C., which can be used for reflow soldering as a basic process in surface mounting technology for mounting electronic components such as chip parts, etc., to a circuit board.

2. Description of Related Art

Recently, operating frequencies of electronic components have increased to enhance high level functionality of electronic devices, and the strength of emissions of electromagnetic noise has increased and the frequency component in a wider range is contained. In such electronic devices, reduction in size and reduction in weight are further required, and also in electronic parts used in the electronic devices, further reduction in size, reduction in thickness, and even higher density packaging are necessary thereby. There is a problem in that electromagnetic noise is easily generated by electronic parts, printed wiring, or wiring between modules, with the increase to higher frequency and higher density packaging.

In general, the composite magnetic material is used in order to block electromagnetic noise in various electronic devices.

As a composite magnetic material, for example, a electromagnetic wave controlling sheet is known, in which atomized powder such as Sendust (Fe—Si—Al alloy), Permalloy (Fe—Ni alloy), Fe—Cr alloy, etc., as soft magnetic metal powder, is dispersed in binder resin such as chlorinated polyethylene rubber, acrylic rubber, ethylene acrylic rubber, etc., and is formed in a sheet shape.

A controlling function for electromagnetic noise of the composite magnetic material depends on thickness, and is supplied by changing a thickness of the composite magnetic material as an application. Therefore, in supplying the composite magnetic material, in order to improve the producing ability, a composite magnetic material having freely selected thickness is produced and a plurality of the materials is laminated according to the requirements of users. With respect to the composite magnetic material using thermosetting resin, magnetic material coating in a liquid state (the A stage) is prepared by dispersing soft magnetic metal powder into liquid resin composition, and a magnetic material sheet in a semicured state (the B stage) is formed by applying and drying the magnetic material coating in a liquid state on a substrate, and a magnetic material sheet in a cured state (the C stage) is produced by curing the sheet in a semicured state. Then, an electromagnetic wave controlling sheet having a desired thickness is produced by laminating and hot-pressing the cured magnetic material sheets as necessary.

In addition, an elementary process in a mounting technique of electronic parts such as chip parts, etc., on the surface of a substrate is reflow soldering. Since heat resistance is low, common composite magnetic materials are softened and deformed by heating in a reflow furnace in reflow soldering, or it is easy to produce an inferior form such as one with local powdering, cracking, breakage, foaming, etc., and therefore, it cannot be used in a high-temperature atmosphere such as in reflow soldering. Therefore, it is necessary to adhere the composite magnetic material after the reflow soldering, and there are problems in the process.

Hitherto, inventions for improving the heat resistance and the flexibility have been proposed.

For example, Japanese Unexamined Patent Application Publication No. Hei11-307983 discloses an electromagnetic wave controlling sheet in which flat soft magnetic metal powder dispersed in polyurethane resin is mounted on an upper surface of semiconductor parts, thermosetting resin such as phenol resin, epoxy resin, unsaturated polyester resin, is applied and fixed so as to cover the electromagnetic wave controlling sheet, and the thermosetting resin is cured by passing it through a solder reflow furnace at 240 degrees C., and thereby, the electromagnetic wave control sheet is sealed and fixed by the thermosetting resin. According to the above electromagnetic wave controlling sheet, deterioration and defects do not occur even after the reflow process.

In addition, Japanese Unexamined Patent Application Publication No. 2002-111276 discloses an electromagnetic wave controlling sheet in which soft magnetic metal powder is embedded in a thermosetting resin sheet made of epoxy resin, unsaturated polyester resin, phenol resin, melamine resin, or urea resin.

Furthermore, Japanese Unexamined Patent Application Publication No. 2005-252221 discloses a compound having at least two carboxyl groups and/or acid anhydride groups in one molecule, a compound having at least two epoxy groups in one molecule, and an electromagnetic wave absorbing material composition containing soft magnetic material powder.

Additionally, Japanese Unexamined Patent Application Publication No. 2012-212790 discloses a magnetic sheet containing magnetic powder, binder resin in which resin composition containing acrylic rubber, phenol resin, epoxy resin, curing accelerator and compound having a melamine structure, is cured, and phosphinic acid metal salt.

However, in the inventions disclosed in the above patent documents, although inferior forming in reflow-soldering could be avoided (reflow resistance), the flexibility requirements could not be satisfied.

Therefore, an object of the present invention is to provide a composite magnetic material that can be efficiently produced and which can simultaneously have satisfactory flexibility and reflow resistance.

Generally, in engineering plastics having high heat resistance, when a filling amount of a soft magnetic metal powder is increased in order to obtain an electromagnetic wave controlling function, it is difficult to obtain a suitable composite magnetic material since the compact is fragile and flexibility is decreased. On the other hand, there are thermoplastic resins having low heat resistance in which the filling amount of soft magnetic metal powder can be increased. However, in a composite magnetic material made of this resin, sufficient heat resistance cannot be obtained.

### SUMMARY OF THE INVENTION

The present inventors conducted research in order to solve the above problems, and as a result, they found that sufficient flexibility, reflow resistance, and long term heat resistant reliability at 150 degrees C. can be simultaneously provided without deteriorating the electromagnetic wave controlling function by mixing acrylic copolymer with an epoxy group and phenol resin at specific ratio, and composite magnetic material having an optional thickness can be efficiently produced by laminating and heating sheets in a semicured state, thereby completing the present invention.

That is, a composite magnetic material of the present invention, contains soft magnetic metal powder and resin composition containing an A component, which is an acryl copolymer with an epoxy group, and a B component, which is a phenol resin, in which the soft magnetic metal powder is dispersed in the resin composition, and a mass ratio denoted by the A component/the B component is 4 to 99.

It is preferable that the A component be an acryl copolymer having a glass transition point temperature of −30 to 40 degrees C., and it is preferable that the A component be an acryl copolymer having a weight-average molecular weight of 100,000 to 3,000,000.

It is preferable that the B component be p-t-butylphenol type resol phenol resin, bisphenol A type resol phenol resin, cresol type resol phenol resin, or cocondensed type resol phenol resin thereof, in which phenolic component is at least one selected from p-t-butylphenol, bisphenol A and cresol. It is more preferable that it be bisphenol A type resol phenol resin.

According to the present invention, the composite magnetic material can be efficiently produced, and it has sufficient flexibility and has long term heat resistance reliability at 150 degrees C. and reflow resistance.

### DESCRIPTION OF PREFERRED EMBODIMENTS

Composite Magnetic Material

In the composite magnetic material according to the present invention, the soft magnetic metal powder is dispersed in the resin composition, and for example, the composite magnetic material is formed in a sheet shape.

Resin Composition

The resin composition in the present invention contains an A component, which is an acrylic copolymer with an epoxy group, and a B component, which is a phenol resin.

The content of the resin composition in the composite magnetic material is preferably 2 to 50 mass %, is more preferably 5 to 40 mass %, and is most preferably 5 to 20 mass %. When the content is less than the above lower limit, there is a problem in that a function as a binder of the soft magnetic metal powder is decreased and formability of the composite magnetic material is also decreased. In contrast, when it is more than the above upper limit, there is a problem in that electromagnetic wave control performance of the composite magnetic material is insufficient.

A Component: Acrylic Copolymer with Epoxy Group

The A component is an acrylic copolymer with an epoxy group, and the epoxy group may be on a side chain of a polymer or may be at a terminal end of the polymer chain.

The acrylic copolymer with an epoxy group is a copolymer in which an acrylate with an epoxy group (including methacrylate, the same hereinafter) and alkyl acrylate (including methacrylate, the same hereinafter) are main components and ethylene, acrylonitrile, styrene, etc., are included as necessary. As an alkyl acrylate, for example, monomers of methyl methacrylate (including methyl methacrylate, the same hereinafter), ethyl acrylate (including ethyl methacrylate, the same hereinafter), propyl acrylate, butyl acrylate (including butyl methacrylate, the same hereinafter), amyl acrylate, hexyl acrylate, octyl acrylate, 2-ethylhexyl acrylate, undecyl acrylate, lauryl acrylate, etc., and monomers with hydroxyl group of 2-hydroxyethyl acrylate, 2-hydroxypropyl acrylate, allyl alcohol, etc., can be used. These monomers may be used alone or in combination. Of these, ethyl acrylate, butyl acrylate, and 2-ethylhexyl acrylate, are preferable in consideration of the flexibility of the composite magnetic material. As an alkyl acrylate with an epoxy group, (meth)acrylic acid glycidyl ester can be used. The content of the epoxy group is preferably an epoxy value of 0.03 to 0.5 eq/kg, is more preferably an epoxy value of 0.05 to 0.4 eq/kg, and is most preferably an epoxy value of 0.07 to 0.3 eq/kg. When the epoxy value is less than the above lower limit, it is difficult to improve the reflow resistance, and in contrast, when the epoxy value is more than the above upper limit, the flexibility tends to decrease.

The A component may be used alone or in combination.

As an acrylic copolymer with an epoxy group, copolymers synthesized by a high pressure radical polymerization, copolymers synthesized by an emulsion polymerization, etc., can be used. In particular, the copolymers synthesized by a high pressure radical polymerization are preferable, since the amount of byproducts generated is small, and it is not necessary to add an emulsifier. The high pressure radical polymerization is not limited, and conventional methods can be used.

The glass transition point temperature of the acrylic copolymer with an epoxy group is preferably −30 to 40 degrees C., is more preferably −25 to 30 degrees C., and is most preferably −20 to 20 degrees C. When the glass transition point temperature is less than the above lower limit, it is difficult to improve the reflow resistance, an in contrast, when it is more than the above upper limit, the flexibility is decreased or it is difficult to laminate the sheets in a semicured state, and as a result, there is a problem in that manufacturing performance of the composite magnetic material is reduced.

The glass transition point temperature is a value measured using a differential thermal analyzer (produced by Seiko Instruments Inc.) according to Japanese Industrial Standard K7121.

The weight-average molecular weight of the acrylic copolymer with an epoxy group is preferably 100,000 to 3,000,000, is more preferably 300,000 to 2,000,000, and is most preferably 500,000 to 1,500,000. When the weight-average molecular weight is within the above range, the heat stability of the composite magnetic material is increased, and the reflow resistance is improved. Furthermore, when the weight-average molecular weight is within the above range, workability and adhesion of the magnetic material coating are improved by improving solvent solubility and lowering melt viscosity. When the weight-average molecular weight is less than the above lower limit, there is a problem in that the heat resistance of the resin composition is decreased and the reflow resistance is decreased. In addition, there are problems in that the melt viscosity of the sheet in a semicured state is reduced and a flow amount of the magnetic material coating is increased in the following film forming step, thereby lowering the workability. In contrast, when the weight-average molecular weight is more than the above upper limit, there are problems in that in the following coating preparing step, solubility in the solvent decreases, and in the following film forming step, fluidity of the magnetic material coating is decreased, so that it is difficult to form the film or to laminate the sheets in a semicured state, and as a result, the producing ability the composite magnetic material is decreased. The weight-average molecular weight is a value measured using a gel permeation chromatography (produced by JASCO Corporation) according to Japanese Industrial Standard K7252.

B Component: Phenol Resin

The B component is a phenol resin. As a B component, conventional phenol resins can be used, and a resol type phenol resin is preferable, since a temperature in laminating the sheets in a semicured state by hot-pressing and a temperature in curing the sheets in a semicured state are decreased, and the adhesive strength is sufficiently obtained between the sheets in a semicured state. As a resol type phenol resin, p-t-butylphenol type resol phenol resins, bisphenol A type resol phenol resins, cresol type resol phenol resins, or cocondensed type resol phenol resins thereof, in which a phenolic component is at least one selected from p-t-butylphenol, bisphenol A and cresol, can be used.

Of these, the bisphenol A type resol phenol resins are preferable as a B component, because they are the most widely used and are the lowest in price.

In the resin composition, the mass ratio denoted by the A component/the B component is 4 to 99. The mass ratio denoted by the A component/the B component is preferably 4 to 19 and is more preferably 4 to 9. When the mass ratio denoted by the A component/the B component is less than 4, the flexibility of the sheets is easily deteriorated after a heat resistant reliability test over 150 degrees C., and in contrast, when it is more than 99, the reflow resistance is not sufficiently obtained.

The greater the total content of the A component and the B component, which are essential components in the resin composition, the greater the effect of the present invention. The total content is preferably 90 mass % or more, is more preferably 95 mass % or more, and is most preferably 100 mass %.

Optional Component in Resin Composition

In the resin composition, resin (optional resin) other than the A component and the B component and an optional component such as a curing accelerator for an acrylic copolymer with an epoxy group (hereinafter generally described as an optional component of a resin composition) may be contained unless effects of the present invention are adversely affected.

As an optional resin, natural rubbers other than the A component, polyimide resins, polyamidimide resins, etc., can be used. These optional resins may be used alone or in combination. The content of the optional resin in the resin composition is preferably 10 mass % or less, and is more preferably 5 mass % or less, and is most preferably substantially 0 mass % (1 mass % or less).

The curing accelerator is not limited as long as a cross-linking reaction of an epoxy group in the acrylic copolymer can be promoted, and for example, tertiary amines such as 1,8-diaza-bicyclo[5.4.0]undecene-7, triethylenediamine, benzyl dimethylamine, triethanolamine, dimethylaminoethanol, tris(dimethylaminomethyl)phenol, etc.; imidazoles such as 2-methyl imidazole, 2-phenyl imidazole, 2-phenyl-4-methyl imidazole, 2-heptadecyl imidazole, etc.; organic phosphines such as tributyl phosphine, methyldiphenyl phosphine, triphenyl phosphine, diphenyl phosphine, phenyl phosphine, etc.; tetraphenyl borates such as tetraphenyl phosphonium tetraphenyl borate, 2-ethyl-4-methyl imidazole tetraphenyl borate, N-methylmorpholine tetraphenyl borate, etc.; or the like, can be used. These curing accelerators may be used alone or in combination.

The content of the curing accelerator in the resin composition is preferably 0.1 to 2 parts by mass for 100 parts by mass of the acrylic copolymer with an epoxy group.

Soft Magnetic Metal Powder

As a soft magnetic metal powder, conventional soft magnetic metal powders used in the composite magnetic material can be used, and for example, pure iron powder, Fe—Si based alloy powder, Fe—Si—Al based alloy powder, Fe—Ni based alloy powder, Fe—Ni—Mo based alloy powder, Fe—Ni—Mo—Cu based alloy powder, Fe—Co based alloy powder, Fe—Ni-Co based alloy powder, Fe—Cr based alloy powder, Fe—Cr—Si based alloy powder, Fe—Ni—Cr based alloy powder, Fe—Cr—Al based alloy powder, etc., can be used. Of these, Fe—Cr based alloy powder such as a PC permalloy powder, Fe—Si based alloy powder, Fe—Si—Al based alloy powder, Fe—Co based alloy powder, and Fe—Ni based alloy powder, having low coercive force, are preferable. The soft magnetic metal powder is produced by a water atomization method, a gas atomization method, a grinding method or a wet method using chemical processing.

As a soft magnetic metal powder, a soft magnetic metal powder in which the above atomized powder is treated by an attritor device or a bead mill, is preferably used. An average particle size or a flattening of the soft magnetic metal powder can be set to be a desired value by such treatment.

The average particle size of the soft magnetic metal powder is preferably 30 to 200 μm. When the average particle size is less than the above lower limit, the magnetic property is easily deteriorated, and in contrast, when it is more than the above upper limit, it is difficult to maintain a desired shape.

The average particle size is a value calculated by a laser diffraction, scattering type particle size and particle size distribution measuring device.

The flattening of the soft magnetic metal powder is preferably 30 to 200, which is powder in a flake shape. When the flattening is less than the above lower limit, the magnetic property is easily deteriorated, and in contrast, when it is more than the above upper limit, it is difficult to maintain a desired shape.

Here, the “flattening” is denoted by Lₐ/dₐ. The Lₐ is an average diameter of the soft magnetic metal powder, and it is obtained by measuring a major axis L and a minor axis S when the soft magnetic metal powder is observed from a plane direction by a SEM (scanning electron microscope), and by calculating an average value (L+S)/2 thereof. The dₐ is a thickness of the soft magnetic metal powder, and it is obtained by polishing the soft magnetic metal powder embedded in the resin, by measuring the maximum thickness dₘₐₓ and the minimum thickness dₘᵢₙ when the powder is observed from a thickness direction by an optical microscope, and by calculating an average value (dₘₐₓ+dₘᵢₙ)/2 thereof.

The content of the soft magnetic powder in the composite magnetic material is set in consideration of the content of the resin composition. The mass ratio denoted by the soft magnetic powder/(the A component+the B component) (hereinafter described as ratio of metal/resin) is preferably 1 to 49, is more preferably 1.5 to 19, and is most preferably 4 to 19. When the ratio of metal/resin is less than the above lower limit, there is a problem in that electromagnetic wave controlling property is decreased, and in contrast, when it is more than the above upper limit, there is a problem in that the soft magnetic metal powder is insufficiently adhered by the resin composition.

Optional Component in Composite Magnetic Material

In the composite magnetic material, optional components such as flame retardants, flame retardant auxiliaries, fillers, mold lubricants, surface treating agents, viscosity modifiers, plasticizers, antibacterial agents, antifungal agents, leveling agents, antifoaming agents, colorants, stabilizers, coupling agents, etc., (hereinafter generally described as an optional component in a composite magnetic material), may be contained, unless effects of the present invention are adversely affected.

As a flame retardant, conventional flame retardants can be used, and for example, at least one of aluminum hydroxide and magnesium hydroxide is preferable from the points of view of being halogen free and further improvement of reflow resistance.

The content of the flame retardant in the composite magnetic material is preferably 40 to 150 parts by mass for 100 parts by mass of the resin composition. When the content is less than the above lower limit, there is a problem in that the sufficient flame resistance cannot be obtained, and in contrast, when it is more than the above upper limit, there is a problem in that the adhesion of the soft magnetic metal powder is insufficient.

As a flame retardant additive, conventional flame retardant additives can be used, and for example, at least one selected from red phosphorus, ammonium polyphosphate, melamine polyphosphate, and phosphate ester is preferable from the point of view of being halogen free.

The content of the flame retardant additive in the composite magnetic material is preferably 1 to 10 parts by mass for 100 parts by mass of the resin composition. When the content is less than the above lower limit, there is a problem in that sufficient flame resistance cannot be obtained, and in contrast, when it is more than the above upper limit, there is a problem in that the heat-resistance is decreased.

The above mass ratio denoted by the flame retardant/(the A component+the B component) is preferably 0.4 to 1.5, and the above mass ratio denoted by the flame retardant additive/(the A component+the B component) is preferably 0.01 to 0.1.

Production Method

As a method for producing the composite magnetic material of the present invention, for example, a method containing: a step for preparing magnetic material coating in which an A component, a B component and soft magnetic metal powder are dispersed in solvent (a coating preparing step), a step for forming a sheet in a semicured state in which the magnetic material coating is applied so as to have a desired thickness and then drying (a film forming step), and a step for curing the sheet in a semicured state by heating (a curing step), can be used.

As a preparing method of the magnetic material coating, conventional preparing methods, for example, a method in which the A component, the B component, and an optional component of the resin composition, as necessary, are added to the solvent and stirred to prepare a resin solution, and then, the soft magnetic metal powder and an optional component of the composite magnetic material, as necessary, are added to the resin solution and mixed, can be used. For example, a method in which the A component, the B component, and an optional component of the resin composition or an optional component of the composite magnetic material, as necessary, are added to the solvent and mixed, and then, the soft magnetic metal powder is further added and mixed, can also be used.

As a solvent used in the coating preparing step, for example, ketone solvents such as methyl ethyl ketone, methyl isobutyl ketone, cyclohexanone, isophorone, etc., ester solvents such as ethyl acetate, butyl acetate, etc., aromatic solvents such as toluene, xylene, etc., cellosolve solvents such as cellosolve acetate, methyl cellosolve acetate, etc., ether solvents such as tetrahydrofuran, diethylene glycol dimethyl ether, etc., alcohols such as isopropanol, n-butyl alcohol, etc., aprotonic polar solvents such as dimethylformamide, etc., can be used.

The content of the solvent in the magnetic material coating is properly set in consideration of viscosity required in the magnetic material coating, etc.

As a film forming step, conventional film forming methods, for example, a method in which magnetic material coating is applied to a peelable film so as to have an optional thickness and is dried, can be used.

As an applying method, applying methods using a bar coater, a comma coater, a die coater, etc., can be used.

The thickness of the sheet in a semi-cured state is not limited, but for example, it is preferably 50 to 500 μm and is more preferably 50 to 100 μm.

As a peelable film, polypropylene films, fluororesin based films, polyethylene films, polyethylene terephthalate (PET) films, papers, and films (peelable-treated film) in which these films are treated with silicone resin, etc., so as to be peelable can be used. The thickness of the peelable film is not limited, but it is preferably 1 to 200 μm and is more preferably 10 to 50 μm. The peel strength of the peelable film is preferably 0.01 to 7.0 g/cm. When the peel strength is more than the above lower limit, the composite magnetic material and the peelable film are not easily separated, and the composite magnetic material is easily handled. In contrast, when the peel strength is less than the above upper limit, the producing ability is increased since defects, etc., are not generated in peeling the composite magnetic material from the peelable film.

The drying step is not limited as long as the resin composition is cured in a semicured state by evaporating solvent in magnetic material coating applied to the peelable film, and for example, a method for heating a magnetic material coating applied to the peelable film at an optional temperature, can be used.

The heating temperature in the film forming step can be set in consideration of the kinds of A component, B component, solvent, etc.

The sheet in a semicured state may be immediately used in the curing step after the drying step, and it may be stored as a workpiece that is being processed.

The curing step is a step for obtaining the composite magnetic material by heating the sheet in a semicured state and curing the resin composition.

As a curing method, conventional curing methods, for example, a method for heating at a freely selected temperature, a method for heating at a freely selected temperature while pressing at a freely selected pressure, etc., can be used.

The heating temperature in the curing step can be set in consideration of the kinds of A component and B component, etc.

When the composite magnetic material is pressed in the curing step, pressure is not limited, but for example, it may be set to be 5 to 30 MPa.

The composite magnetic material in which the resin composition is cured in a cured state is made into a product by cutting out at a desired size.

In the curing step, the composite magnetic material may be produced by laminating the sheets in a semicured state so as to have a thickness of a final product, and curing for example, using a hot press. When the sheet in a semicured state is heated, the above acrylic copolymer with an epoxy group is adhered to the contacting surface by surface tackiness.

Before or after the curing step, another peelable film may be provided on an exposed surface of the semicured sheet on the peelable film or on an exposed surface of the composite magnetic material, as necessary. Thus, adhesion of foreign matter, etc., can be prevented by providing the peelable film on both surfaces of the composite magnetic material.

In addition, a heat-resistant adhesive layer may be provided on one surface or both surfaces of the composite magnetic material. The composite magnetic material can be easily affixed to an object to which it is to be adhered by the heat-resistant adhesive layer.

As an adhesive for forming the heat-resistant adhesive layer, conventional adhesives, for example, methylphenyl based silicone adhesives, addition reaction type silicone adhesives, peroxide sulfuration type silicone adhesives, etc., can be used.

As described above, according to the present invention, appropriate flexibility and reflow resistance can be simultaneously provided by containing the A component and the B component at a specific ratio.

### EXAMPLES

In the following, the present invention will be explained based on Examples; however, the present invention is not limited to these Examples.

### Example 1

Spherical powder having an average particle diameter of 100 μm was prepared by gas-atomizing molten metal of a Fe—Si—Al alloy. Soft magnetic metal powder having an average particle diameter of 50 μm, a thickness of 1 μm, and a flattening of 50 was produced by stirring the spherical powder in an attritor device.

8 parts by mass of an A component: acrylic copolymer with an epoxy group having an epoxy value of 0.21 eq/kg, a glass transition point temperature of 12 degrees C., and a weight-average molecular weight of 850,000 (trade name: Teisanresin SG-P3 (solid content of 15%), produced by Nagase ChemteX Corporation), 2 parts by mass of a B component: bisphenol A type cocondensed resol phenol resin (trade name: CKM-908, produced by Showa Denko K.K.), 10 parts by mass of flame retardant: aluminum hydroxide, and 0.6 parts by mass of flame retardant additive: red phosphorus were stirred in 103 parts by mass of methyl ethyl ketone. Then, magnetic material paint was prepared by mixing after adding 80 parts by mass of the above soft magnetic metal powder.

The magnetic material paint was applied to a peel-treated surface of a peel-treated film (made of PET) so as to have a dry thickness of 130 μm, and it was heated in a hot air circulating oven at 150 degrees C. for 2 minutes, and therefore, a sheet in a semi-cured state was formed. With respect to the formed sheet in a semicured state, the laminating characteristics were evaluated. In addition, in order to improve the orientation of the soft magnetic metal powder, a composite magnetic material having a thickness of 99 μm was produced by pressing, at a pressure of 20 MPa, the sheet in a semicured state at 160 degrees C. for 60 minutes, using a hot press. With respect to the produced magnetic material, magnetic permeability, reflow resistance, flexibility, ability to relax internal stress, and laminating characteristics, were evaluated, and the composition of the composite magnetic material and evaluation results are shown in Table 1.

### Example 2

A sheet in a semicured state and a composite magnetic material having a thickness of 100 μm were produced in the same manner as in Example 1, except that a soft magnetic metal powder having an average particle diameter of 30 μm, a thickness of 1 μm, and a flattening of 30 was used as the soft magnetic metal powder. With respect to the produced magnetic material, magnetic permeability, reflow resistance, flexibility, ability to relax internal stress, and laminating characteristics, were evaluated, and the composition of the composite magnetic material and evaluation results are shown in Table 1.

### Example 3

A sheet in a semicured state and a composite magnetic material having a thickness of 100 μm were produced in the same manner as in Example 1, except that a soft magnetic metal powder having an average particle diameter of 50 μm, a thickness of 2 μm, and a flattening of 25 was used as the soft magnetic metal powder. With respect to the produced magnetic material, magnetic permeability, reflow resistance, flexibility, ability to relax internal stress, and laminating characteristics, were evaluated, and the composition of the composite magnetic material and evaluation results are shown in Table 1.

### Example 4

A sheet in a semicured state and a composite magnetic material having a thickness of 98 μm were produced in the same manner as in Example 1, except that a soft magnetic metal powder made of a Fe—Si alloy having an average particle diameter of 49 μm, a thickness of 1 μm, and a flattening of 30 was used as the soft magnetic metal powder. With respect to the produced magnetic material, magnetic permeability, reflow resistance, flexibility, ability to relax internal stress, and laminating characteristics, were evaluated, and composition of the composite magnetic material and evaluation results are shown in Table 1.

### Example 5

A sheet in a semicured state and a composite magnetic material having a thickness of 98 μm were produced in the same manner as in Example 1, except that a soft magnetic metal powder made of a Fe—Ni alloy having an average particle diameter of 52 μm, a thickness of 1 μm, and a flattening of 52 was used as the soft magnetic metal powder. With respect to the produced magnetic material, magnetic permeability, reflow resistance, flexibility, ability to relax internal stress, and laminating characteristics, were evaluated, and composition of the composite magnetic material and evaluation results are shown in Table 1.

### Example 6

A sheet in a semicured state and a composite magnetic material having a thickness of 100 μm were produced in the same manner as in Example 1, except that the amount of the soft magnetic metal powder mixed therein was 180 parts by mass. With respect to the produced magnetic material, magnetic permeability, reflow resistance, flexibility, ability to relax internal stress, and laminating characteristics, were evaluated, and composition of the composite magnetic material and evaluation results are shown in Table 2.

### Example 7

A sheet in a semicured state and a composite magnetic material having a thickness of 103 μm were produced in the same manner as in Example 1, except that the A component was an acrylic copolymer with an epoxy group having an epoxy value of 0.07 eq/kg, a glass transition point temperature of −14 degrees C., and a weight-average molecular weight of 700,000. With respect to the produced magnetic material, magnetic permeability, reflow resistance, flexibility, ability to relax internal stress, and laminating characteristics, were evaluated, and composition of the composite magnetic material and evaluation results are shown in Table 2.

### Example 8

A sheet in a semicured state and a composite magnetic material having a thickness of 100 μm were produced in the same manner as in Example 1, except that the A component was an acrylic copolymer with an epoxy group having an epoxy value of 0.21 eq/kg, a glass transition point temperature of 12 degrees C., and a weight-average molecular weight of 1,200,000 (trade name: Teisanresin (solid content of 15%). With respect to the produced magnetic material, magnetic permeability, reflow resistance, flexibility, ability to relax internal stress, and laminating characteristics, were evaluated, and composition of the composite magnetic material and evaluation results are shown in Table 2.

### Example 9

A sheet in a semicured state and a composite magnetic material having a thickness of 101 μm were produced in the same manner as in Example 1, except that the B component was p-t-butylphenol type resol phenol resin (trade name: CKM-1282, produced by Showa Highpolymer Co., Ltd.). With respect to the produced magnetic material, magnetic permeability, reflow resistance, flexibility, ability to relax internal stress, and laminating characteristics, were evaluated, and composition of the composite magnetic material and evaluation results are shown in Table 2.

### Example 10

A sheet in a semicured state and a composite magnetic material having a thickness of 99 μm were produced in the same manner as in Example 1, except that amounts of the A component and the B component mixed therein were 9 parts by mass and 1 part by mass, respectively. With respect to the produced magnetic material, magnetic permeability, reflow resistance, flexibility, ability to relax internal stress, and laminating characteristics were evaluated, and composition of the composite magnetic material and evaluation results are shown in Table 2.

### Example 11

A sheet in a semicured state and a composite magnetic material having a thickness of 99 μm were produced in the same manner as in Example 1, except that the amounts of the A component and the B component mixed therein were 9.9 parts by mass and 0.1 parts by mass, respectively. With respect to the produced magnetic material, magnetic permeability, reflow resistance, flexibility, ability to relax internal stress, and laminating characteristics, were evaluated, and composition of the composite magnetic material and evaluation results are shown in Table 2.

### Comparative Example 1

A sheet in a semicured state and a composite magnetic material having a thickness of 100 μm were produced in the same manner as in Example 1, except that chlorinated polyethylene (chlorinated PE) was used instead of the A component and the B component. With respect to the produced magnetic material, magnetic permeability, reflow resistance, flexibility, ability to relax internal stress, and laminating characteristics, were evaluated, and composition of the composite magnetic material and evaluation results are shown in Table 3.

### Comparative Example 2

A sheet in a semicured state and a composite magnetic material having a thickness of 99 μm were produced in the same manner as in Example 1, except that amounts of the A component and the B component mixed therein were 6 parts by mass and 4 parts by mass, respectively. With respect to the produced magnetic material, magnetic permeability, reflow resistance, flexibility, ability to relax internal stress, and laminating characteristics, were evaluated, and composition of the composite magnetic material and evaluation results are shown in Table 3.

### Comparative Example 3

A sheet in a semicured state and a composite magnetic material having a thickness of 98 μm were produced in the same manner as in Example 1, except that amounts of the A component, the B component, the soft magnetic metal powder, aluminum hydroxide, and red phosphorus mixed therein were 28 parts by mass, 7 parts by mass, 30 parts by mass, 35 parts by mass, and 2.1 parts by mass, respectively. With respect to the produced magnetic material, magnetic permeability, reflow resistance, flexibility, ability to relax internal stress, and laminating characteristics, were evaluated, and composition of the composite magnetic material and evaluation results are shown in Table 3.

### Comparative Example 4

A sheet in a semicured state and a composite magnetic material having a thickness of 99 μm were produced in the same manner as in Example 1, except that amounts of the A component and the B component mixed therein were 10 parts by mass and 0 parts by mass, respectively. With respect to the produced magnetic material, magnetic permeability, reflow resistance, flexibility, ability to relax internal stress, and laminating characteristics, were evaluated, and composition of the composite magnetic material and evaluation results are shown in Table 3.

Evaluating Methods

In the following, methods for evaluating the above composite magnetic materials will be described.

### Magnetic Permeability

With respect to the above composite magnetic materials, real terms and imaginary terms were calculated, and composite magnetic materials in which the real term was 80 or more and the imaginary term was 20 or more were evaluated as excellent represented by a circle, and composite magnetic materials in which the real term was less than 80 and the imaginary term was less than 20 were evaluated as failures represented by a cross.

Real Term of Magnetic Permeability

The above composite magnetic materials were punched out in a ring shape having an outer diameter of 7 mm and an inner diameter of 3 mm, and test pieces were produced by winding the materials so as to have 12 turns. With respect to the test pieces, a real term of magnetic permeability was calculated by impedance at 1 MHz measured by an impedance measuring device (trade name: Precision Impedance Analyzer HP 4294A, produced by Agilent Technologies).

Imaginary Term of Magnetic Permeability

With the test pieces produced in the “Real Term of Magnetic Permeability”, loss term was measured in a range of 1 MHz to 10 GHz by an S parameter measuring device (trade name: Network Analyzer E5071C, produced by Agilent Technologies), and the maximum value thereof was set to be an imaginary term.

Reflow Resistance

Test pieces were produced by cutting the above composite magnetic materials in a shape having a length of 50 mm and a width of 50 mm. With respect to the test pieces, a solder reflow test (2 times for 10 seconds at 260 degrees C.) was carried out according to 10.4.1 “a solder float method” in “test methods for printed wiring boards” of the Japanese Industrial Standard C-5012. The test pieces after the solder reflow test were evaluated according to the following evaluating criteria by visual inspection.

Evaluating Criteria
Double Circles: Appearance of the test piece did not change at all, even by carrying out the reflow test.
Circles: Appearance of the test piece hardly changed, even by carrying out the reflow test.
Triangles: After the reflow test, the test piece was deformed; however, expansion, powdering, breakage and cracking were not observed.
Crosses: Expansion, powdering, breakage or cracking was observed by the reflow test.

Flexibility

Test pieces were produced by cutting the above composite magnetic materials in a shape having a length of 50 mm and a width of 50 mm. With respect to the test pieces, a solder reflow test (2 times for 10 seconds at 260 degrees C.) was carried out according to 10.4.1 “a solder float method” in “test methods for printed wiring boards” of the Japanese Industrial Standard C-5012. The test pieces before the solder reflow test and the test pieces after the solder reflow test were bent under the following testing conditions: bending speed of 175 times/minute, bending angle of 135 degrees, and load of 4.9 N, using an MIT Folding and Abrasion Tester, model number: DA, produced by Toyo Seiki Seisaku-sho, Ltd. The bent test pieces were evaluated according to the following evaluating criteria by visual inspection.

Evaluating Criteria
Double Circles: Whitening, breakage and cracking were not observed at the bending portion at all.
Circles: Breakage and cracking were not observed; however, whitening was observed.
Triangles: Breakage or cracking was observed at the bending portion.
Crosses: The test piece was cut off at the bending portion.

Ability of Relax Internal Stress

Test pieces were produced by adhering the composite magnetic material to a commercially available glass epoxy-printed wiring board at 150 degrees C. and pressing it using a hot press at 150 degrees C. and 20 MPa. With respect to the test pieces, a heat cycle test having 50 cycles (1 cycle was 120 degrees C. for 2 hours and −20 degrees C. for 2 hours) was carried out. The test pieces after the heat cycle test were evaluated according to the following evaluating criteria by visual inspection.

Evaluating Criteria
Double Circles: Appearance of the test piece did not change at all, even by carrying out the heat cycle test.
Circles: Appearance of the test piece hardly changed, even by carrying out the heat cycle test.
Triangles: After the heat cycle test, the test piece was deformed; however, expansion, powdering, breakage and cracking were not observed.
Crosses: Expansion, powdering, breakage or cracking was observed by the heat cycle test.

Laminating Characteristics

Three sheets of the composite magnetic material in a semicured sheet were laminated by hot-pressing at 150 degrees C. and 20 MPa for 10 seconds. The state of adhesion of the composite magnetic materials after hot-pressing was evaluated according to the following evaluating criteria by visual inspection.

Evaluating Criteria
Double Circles: Boundary of each layer was not visible, and one composite magnetic material was formed of three sheets.
Circles: Boundary of each layer was visible; however, each layer was adhering and did not peel away.
Triangles: Boundary of each layer was visible, and each layer could be peeled away by using the fingers.
Crosses: Each layer peeled away and was separated (in a state in which efficient production was not possible).

TABLE 1

| | | | Example | | | | |
|---|---|---|---|---|---|---|---|
| | | | 1 | 2 | 3 | 4 | 5 |
| Compositions | Soft magnetic | Kinds | Fe—Si—Al | Fe—Si—Al | Fe—Si—Al | Fe—Si | Fe—Ni |
| | metal powder | Average particle diameter (μm) | 50 | 30 | 50 | 49 | 52 |
| | | Thickness (μm) | 1 | 1 | 2 | 1 | 1 |
| | | Flatting | 50 | 30 | 25 | 30 | 52 |

| | | | | | | |
|---|---|---|---|---|---|---|
| A component | Epoxy value | 0.21 | 0.21 | 0.21 | 0.21 | 0.21 |
| | Glass transition | 12 | 12 | 12 | 12 | 12 |
| | point temperature | | | | | |
| | Weight-average | 850,000 | 850,000 | 850,000 | 850,000 | 850,000 |
| | molecular weight | | | | | |
| B component | Bisphenol A type | ◯ | ◯ | ◯ | ◯ | ◯ |
| | p-t-butyl phenol type | — | — | — | — | — |

| | | Mass ratio of A/B | 4 | 4 | 4 | 4 | 4 |
|---|---|---|---|---|---|---|---|
| | Mass ratio of soft magnetic metal powder/(A + B) | | 8 | 8 | 8 | 8 | 8 |
| Results | Magnetic | Real term | 93.4 | 92.4 | 91.6 | 90.1 | 90.7 |
| | permearability (%) | Imaginary term | 25.3 | 25.3 | 25.9 | 25.4 | 24.1 |
| | | Judgment | ◯ | ◯ | ◯ | ◯ | ◯ |
| | Reflow resistance | | ⊚ | ⊚ | ⊚ | ⊚ | ⊚ |
| | Flexibility | Before reflow test | ⊚ | ⊚ | ⊚ | ⊚ | ⊚ |
| | | After reflow test | ⊚ | ⊚ | ⊚ | ⊚ | ⊚ |

| | | | | | |
|---|---|---|---|---|---|
| Ability of relax internal stress | ⊚ | ⊚ | ⊚ | ⊚ | ⊚ |
| Laminating characteristics | ⊚ | ⊚ | ⊚ | ⊚ | ⊚ |

TABLE 2

| | | | Example | | | | | |
|---|---|---|---|---|---|---|---|---|
| | | | 6 | 7 | 8 | 9 | 10 | 11 |
| Compositions | Soft | Kinds | Fe—Si—Al | Fe—Si—Al | Fe—Si—Al | Fe—Si—Al | Fe—Si—Al | Fe—Si—Al |
| | magnetic | Average particle diameter | 50 | 50 | 50 | 50 | 50 | 50 |
| | metal | (μm) | | | | | | |
| | powder | Thickness (μm) | 1 | 1 | 1 | 1 | 1 | 1 |
| | | Flatting | 50 | 50 | 50 | 50 | 50 | 50 |

| | | | | | | | |
|---|---|---|---|---|---|---|---|
| A component | Epoxy value | 0.21 | 0.07 | 0.21 | 0.21 | 0.21 | 0.21 |
| | Glass | 12 | −14 | 12 | 12 | 12 | 12 |
| | transition | | | | | | |
| | point | | | | | | |
| | temperature | | | | | | |
| | Weight- | 850,000 | 700,000 | 1,200,000 | 850,000 | 850,000 | 850,000 |
| | average | | | | | | |
| | molecular | | | | | | |
| | weight | | | | | | |
| B component | Bisphenol | ◯ | ◯ | ◯ | — | ◯ | ◯ |
| | A type | | | | | | |
| | p-t-butyl | — | — | — | ◯ | — | — |
| | phenol | | | | | | |
| | type | | | | | | |

| | | Mass ratio of A/B | 4 | 4 | 4 | 4 | 9 | 99 |
|---|---|---|---|---|---|---|---|---|
| | Mass ratio of soft magnetic | | 18 | 8 | 8 | 8 | 8 | 8 |
| | metal powder/(A + B) | | | | | | | |
| Results | Magnetic | Real term | 83.5 | 91.5 | 91.6 | 92.3 | 92.4 | 92.3 |
| | permearability | Imaginary term | 21.5 | 25.4 | 25.5 | 25.8 | 25 | 25.1 |
| | (%) | Judgment | ◯ | ◯ | ◯ | ◯ | ◯ | ◯ |
| | Reflow resistance | | ⊚ | ⊚ | ⊚ | ⊚ | ⊚ | ⊚ |
| | Flexibility | Before reflow test | ⊚ | ⊚ | ⊚ | ⊚ | ⊚ | ⊚ |
| | | After reflow test | ⊚ | ⊚ | ⊚ | ⊚ | ⊚ | ⊚ |

| | | | | | | |
|---|---|---|---|---|---|---|
| Ability of relax internal stress | ⊚ | ⊚ | ⊚ | ⊚ | ⊚ | ⊚ |
| Laminating characteristics | ⊚ | ⊚ | ⊚ | ⊚ | ⊚ | ⊚ |

TABLE 3

| | | | Comparative Example | | | |
|---|---|---|---|---|---|---|
| | | | 1 | 2 | 3 | 4 |
| Compositions | Soft magnetic | Kinds | Fe—Si—Al | Fe—Si—Al | Fe—Si—Al | Fe—Si—Al |
| | metal powder | Average particle diameter (μm) | 50 | 50 | 50 | 50 |
| | | Thickness (μm) | 1 | 1 | 1 | 1 |
| | | Flatting | 50 | 50 | 50 | 50 |

| | | | | | |
|---|---|---|---|---|---|
| A component | Epoxy value | Chlorinated | 0.21 | 0.21 | 0.21 |
| | Glass transition | PE | 12 | 12 | 12 |
| | point temperature | | | | |
| | Weight-average | | 850,000 | 850,000 | 850,000 |
| | molecular weight | | | | |
| B component | Bisphenol A type | | ◯ | ◯ | — |
| | p-t-butyl phenol type | | — | — | — |

| | | Mass ratio of A/B | | 1.5 | 4 | — |
|---|---|---|---|---|---|---|
| | Mass ratio of soft magnetic metal powder/(A + B) | | 8 | 8 | 0.86 | 8 |
| Results | Magnetic | Real term | 100.4 | 92.6 | 52.3 | 93.1 |
| | permearability (%) | Imaginary term | 29.7 | 25.9 | 10.2 | 25 |
| | | Judgment | ◯ | ◯ | X | ◯ |
| | Reflow resistance | | X | ⊚ | ⊚ | X |
| | Flexibility | Before reflow test | ⊚ | X | ⊚ | ⊚ |
| | After reflow test | — | X | ⊚ | ⊚ | |

| | | | | |
|---|---|---|---|---|
| Ability of relax internal stress | ⊚ | X | ⊚ | ⊚ |
| Laminating characteristics | ⊚ | ◯ | ⊚ | ⊚ |

Tables 1 to 3 show the compositions of the composite magnetic materials and the evaluation results.

As described in Tables 1 and 2, in all Examples 1 to 11 which apply to the present invention, the magnetic permeability was evaluated as a circle, and the electromagnetic noise generated by an electronic device, etc., was sufficiently absorbed. In addition, in Examples 1 to 11, the ability to relax internal stress was evaluated as a double circle, and degradation was unlikely to occur in long-term use. Furthermore, in Examples 1 to 11, the reflow resistance, the flexibility, and the laminating characteristics were evaluated as a double circle.

In contrast, as described in Table 3, in Comparative Example 1 in which the resin composition was polyethylene chloride, the reflow resistance was evaluated as a cross, and after the solder reflow test, the deformation was remarkable, and the flexibility could not be evaluated. In Comparative Example 2 in which the mass ratio of A/B was 1.5, the flexibility was evaluated as a cross, and in Comparative Example 3 in which the mass ratio of the soft magnetic metal powder/(A+B) was 0.86, the magnetic permeability was evaluated as a cross. In addition, in Comparative Example 4 in which the B component was not contained, the reflow resistance was evaluated as a cross.

As is apparent from these results, it has been proven that, according to the present invention, the composite magnetic material had sufficient flexibility and was produced at a high producing ability without having inferior form.

What is claimed is:

1. A composite magnetic material comprising:
soft magnetic metal powder; and
resin composition containing an A component, which is an acryl copolymer with an epoxy group, and a B component, which is phenol resin,
wherein the soft magnetic metal powder is dispersed in the resin composition, and
a mass ratio denoted by the A component/the B component is 4 to 99.

2. The composite magnetic material according to claim 1, wherein the soft magnetic metal powder is powder in a flake shape having an average particle diameter of 30 to 200 μm and a flattening of 30 to 200, in which atomized powder made of soft magnetic metal or alloy is flattened.

3. The composite magnetic material according to claim 1, wherein the soft magnetic metal powder is at least one selected from Fe—Si based alloy powder, Fe—Si—Al based alloy powder, Fe—Ni based alloy powder, Fe—Ni—Mo based alloy powder, Fe—Ni—Mo—Cu based alloy powder, and Fe—Cr based alloy powder.

4. The composite magnetic material according to claim 1, wherein a mass ratio denoted by the soft magnetic metal powder/the A component+the B component) is 1 to 49.

5. The composite magnetic material according to claim 1, wherein the A component is an acryl copolymer having a glass transition point temperature of −30 to 40 degrees C.

6. The composite magnetic material according to claim 1, wherein the A component is an acryl copolymer having a weight-average molecular weight of 100,000 to 3,000,000.

7. The composite magnetic material according to claim 1, wherein the B component is a resol type phenol resin.

8. The composite magnetic material according to claim 1, further comprising a flame retardant made of at least one of aluminum hydroxide and magnesium hydroxide having an average particle diameter of 0.1 to 3 μm, and a flame retardant additive made of at least one selected from red phosphorus, ammonium polyphosphate, melamine polyphosphate, and phosphate ester.

9. The composite magnetic material according to claim 8, wherein a mass ratio denoted by the flame retardant/(the A component+the B component) is 0.4 to 1.5, and a mass ratio denoted by the flame retardant additive/(the A component+the B component) is 0.01 to 0.1.

10. The composite magnetic material according to claim 1, wherein a heat-resistant adhesive layer is laminated on one surface of the composite magnetic material, or heat-resistant adhesive layers are laminated on both surfaces of the composite magnetic material.
